(19) United States
(12) Patent Application Publication
(10) Pub. No.: US 2011/0298205 A1
(43) Pub. Date: Dec. 8, 2011

(54) IDENTIFICATION DOCUMENT WITH AN IMPROVED ANTI-COUNTERFEITING ELEMENT

(75) Inventor: Teemu Pohjola, Meudon (FR)

(73) Assignee: GEMALTO OY, Vantaa (FI)

(21) Appl. No.: 13/140,044

(22) PCT Filed: Dec. 18, 2009
(86) PCT No.: PCT/EP2009/067488

§ 371 Date: Aug. 23, 2011

(30) Foreign Application Priority Data
Dec. 18, 2008 (EP) 08172207.6

(51) Int. Cl. B42D 15/00; B23P 11/00

(52) U.S. Cl. 283/75; 29/428

(57) ABSTRACT

An identification document including a translucent portion is provided. The translucent portion has a first side and a second side, and includes a first personalized information. The first personalized information includes a second personalized information which is hidden in the first personalized information when viewed from the first side of the translucent portion. A filtering device is attached to or formed in the second side of the translucent portion. The filtering device is configured to reveal the hidden second personalized information. The second personalized information appears superimposed onto the first personalized information when viewed from the second side of the translucent portion, and remains hidden when viewed from the first side of the translucent portion.

### BACKGROUND

This invention relates generally to identification documents and a method for making such identification documents. More particularly, this invention relates to a secure identification document that allows detecting a fraudulent modification of the existing personalization or a completely falsified document. The invention also relates to a method for making such a document.

Identification documents are associated with secure applications, such as for example driving licenses, identity cards, membership cards, badges or passes, passports, discount cards, banking cards, money cards, multi-application cards, and other papers of value; and security documents such as bank notes. Such documents are widely used, they may comprise an electronic module or not. If they comprise an electronic module, they can function either with contact and/or without contacts depending on the application to which they are intended for. They may take the shape of card or a booklet or something else. Such identification documents are graphically personalized. Personalized information is personal data of the card's owner, i.e for example his photo, his name, his birth date, his social security number, his biometric information such as his fingerprint for example, a validity date, an identification number allocated to him etc . . . This personalized information is printed onto the surface of the document, or into one or more constitution layers of the document. Because of the value and importance associated with each of these data carriers, they are often the subject of unauthorized copying and alterations, and forgeries.

To prevent such activities from being carried out on these data carriers, different types of visual and touchable security features have been added to data carriers. One of these security features consists in providing, into the document, an optically variable security element, which comprises at least two security markings. Said markings are decomposed and interleaved, to create a complex image that is printed into the document. Then, a filter is placed over this complex image, said filter being arranged so that it enables to visualize each marking at a respective particular angle by tilting the document.

Another existing security feature consists in adding in the picture of the owner for instance that is printed onto the opaque body of the document, a hidden image, which is an image inserted either into the background or into personalized image, in such a way that it is not seen with naked eyes. Such hidden image can then be viewed through an appropriate separate filtering device for authentication. Such process for inserting a hidden image into a first image has been described in document EP1048168.

A further existing security feature is a clear or see-through portion through the thickness of a data carrier. Such see-through portion comprises security markings that are visible either under visible light beam or under fluorescent light beam. Such see-through portion is difficult to copy with a scanner but, depending on the type of the security markings, an infringer could still reproduce at least a look-alike of the see-through portion, or personalize stolen blank documents and reproduce a look alike of such document with see-through portion, or cut such see-through portion from one document, in order to insert it into another document, or falsify the security markings by adding some other markings into the see-though portion.

For improving the security of such see-trough portions, patent application EP1698485 describes a method to incorporate micro-printings onto the back side, readable with a magnifier, and arranged to be viewed as a phase shifted image from the other side through a lenticular array. In this case, micro-printings are always visible from both sides, so that it remains possible for an infringer to modify these printings.

Considering the above, a problem intended to be solved by the invention, is to propose an identification document comprising a see-through portion having a first side and a second side, said see-through portion comprising first personalized information, said identification document being made so that the see-through portion enables to visualize different personalized information from its both sides, in such a manner that it becomes impossible for an infringer either to modify the personalized information or to remove the see-through portion and to replace it by another completely falsified see-through portion.

### SUMMARY

The solution of the invention to this problem relates to the fact that:
said first personalized information comprises a second personalized information, which is hidden into the first personalized information when viewed from the first side,
a filtering device is provided on the second side of the see-through portion, in order to reveal the hidden second personalized information, which appears superimposed onto the first personalized information, when viewed from said second side, while it remains hidden when viewed from the first side.

Thus, thanks to the processing of an image comprising an inserted hidden second personalized information into a first personalized information; to the insertion of said processed image into a see-though portion; and to the integration of a filtering device on one side of the see-through portion, it is possible to view the first personalized information from both sides of the see-though portion, while the second hidden personalized information appears superimposed onto the first one only when viewed through the filtering device, from the side holding said filtering device.

Then, if an infringer wants to modify the information embedded into the see-through portion, it becomes very difficult to modify the second personalized information, without affecting the first personalized information and reciprocally. Moreover, because the information embedded into the see-through portion is linked to the identity of the holder, and is difficult to modify, it becomes also impossible to remove it in order to replace it by another falsified see-through portion, or to reproduce a look-alike of the see-through portion.

According to another aspect, the invention relates also to a method for manufacturing such an identification document. The method comprises the following steps:
processing an image, said image comprising first personalized information together with second personalized information inserted and hidden into the first one,
inserting said processed image either into the thickness of the see-through portion or onto the surface of a first side of the see-through portion,
providing a filtering device into or onto a second side of the see-through portion, in such a manner that it faces the processed image through a thickness of the see-through portion, so that hidden second personalized information appears superimposed onto the first personalized information when viewed from this second side, while it remains hidden and only the first personalized information appears when viewed from the first side of the see-though portion.

### BRIEF DESCRIPTION OF DRAWINGS

Other particularities and advantages of the invention will be better understood with the help of the description below, which has been provided as an illustrative and non !imitative example by reference to the enclosed figures that represent:

FIGS. 1A and 1B, respectively front view and rear view of an identification document according to the invention,

FIG. 2, a schematic cross-sectional view along line I-I of the document of FIG. 1A.

### DETAILED DESCRIPTION

Hereafter, an embodiment of the present invention will be described in the context of identity (ID) card and a method for producing it. However, it is to be understood that the invention is usable with any data carrier that includes, but is not limited to, a driving license, a badge or pass, a passport, a discount card, a membership card, a banking card, a credit card, a money card, a multi-application card, and other security documents and papers of value that are to be provided with information or data in such a way that they cannot be easily imitated by common means. Such identification documents may take indifferently the shape of card, or booklet, or something else.

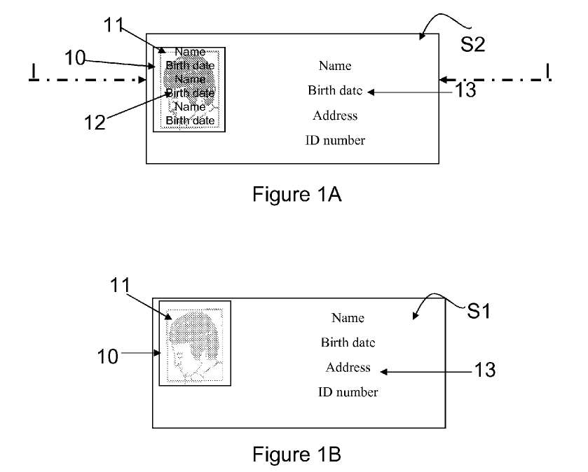

FIG. 1A shows for example a front side S2 of an identification document, while FIG. 1B shows the other side S1 of the same identification document. The document holds personalized information 13, such as the name of its owner, and/or his birth date, and/or his address and/or an identification number allocated to him for example etc . . . . These data are for example printed or laser-engraved on or into a constitution layer of the body of the document. In addition, these data 13 can be applied on both sides S1, S2 of the document. The document comprises also a see-through portion 10 enabling viewing some information through it, for the authentication of the document. The information that is viewed through the see-through portion 10 is not the same depending from which side S1 or S2 it is viewed.

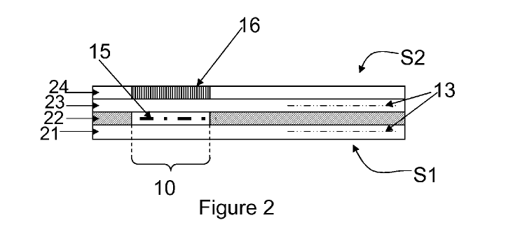

Indeed, as it can be seen on FIGS. 1A and 1B, first personalized information 11, which is the photograph of the owner in the illustrated example, can be viewed from both sides but it looks different. In the illustrated example, the first personalized information is the photograph of the card's holder. However, this is only an example, and the first personalized information can be other background or picture such as biometric picture for example. The photograph 11 can be viewed alone from first side S1, while it appears with superimposed second personalized information 12 when viewed from the other side S2. This is because, before its insertion into or onto the see-through portion 10, the first personalized information 11 is processed so that the second personalized information 12 is inserted into it, in such a manner that it is hidden to naked eyes. The second personalized information 12 can in fact only appear to naked eye when it is viewed through a filtering device. For that, the document also incorporates a filtering device applied either on top of the second side S2 of the see-through portion 10, or just beneath the top of this second side. This filtering device will be described in more details in regards with FIG. 2.

The hidden second personalized information 12 that can be viewed only through a filtering layer comprises for example some personalized information of the owner such as his name, and/or birth date etc . . . This second personalized information 12 can be, but is not limited to, at least a part of the information 13 printed on the remaining body of the document. Thus, if a fraudulent person tries to remove the see-through portion 10 for replacing it by another falsified, the fraud appears immediately to naked eyes because one can no more view the second personalized information, which must match at least partially with the personalized information 13 that is applied on the remaining body.

FIG. 2 is a schematic cross-sectional view along line I-I of FIG. 1A. In the illustrated example, the identification document comprises several layers that are attached together by lamination process, or by gluing, or by ultrasonic process or by any other conventional process for example. The layers can be made with polycarbonate. This material is very interesting because, when the polycarbonate layers are laminated together, they are fused and form only one piece instead of collated layers that could be delaminated. However, invention is not limited to this preferred embodiment, and layers made in other plastic material, such as PVC, ABS, PET etc; . . . can also be used.

In the illustrated example, layers 22, 23 can be for example opaque or clear, and laser sensitive or not. However, in area 10, intended to form with other layers the see-through portion through the thickness of the body of the document, these layers have to be clear. On the other hand, layers 21 and 24 are at least translucent, in order to be able to view markings 13 printed onto lower layers for example, and they are laser sensitive or not.

Personalized information 13 relating to the identity of the holder are either printed or laser-engraved into at least one layer 21, 23, 24 and/or onto at least one layer 22, 23. These data 13 are visible through the upper layers 21, 24 at least translucent.

A see-through portion 10 is provided, by any conventional process, through the thickness of the attached layers 21-23. Then, a processed image 15 is either printed or laser engraved, either into the thickness of the see-through portion, into at least one of the constitution layers of the see-through portion, or onto a first external surface S1 of the see-through portion, i.e. onto external surface of layer 21 in the illustrated example of FIG. 2. The processed image 15 is computed with the help of a computer algorithm, in order to insert a second hidden personalized information 12 into a first personalized information 11. In the example of the invention, the first personalized information 11 is the picture of the card's holder, while the second inserted hidden personalized information 12 is for example an alphanumeric identity information of the holder.

The upper layer 24 covering the second surface S2 of the document comprises a filtering device 16 intended to reveal the second information 12 as superimposed onto the first information 11 when viewed from the second side S2 through the filtering device 16. On the other hand, when the image 15 is viewed from the first side S1, only the first personalized image 11 can be viewed, but not the second information, which remains hidden into the first one.

However, in a variant of realization, the filtering device can also be provided in a layer beneath the upper layer 24, for example in layer 23, provided that there is a sufficient thickness remaining between the filtering device 16 and the processed image 15 in order to have good results. Typically, this thickness must be at least 100 μm.

Of course, the embodiment, which has just been described in regards with FIG. 2, is only an example and the invention is not limited to a multilayer document. Indeed, it is also possible to manufacture a document comprising only one constitution layer, at least translucent. In that case, the processed image is applied onto or into one side of the document, while the filtering device is applied on the other side, so that these two elements are separated from each other by a sufficient thickness of a transparent piece.

The filtering device 16 can be either a diffractive element or a lens, itself consisting either in a lenticular shape or in printed lines, typically parallel printed lines for instance. The lenticular shape is preferred compared to printed lines because with printed lines the processed image 15 to be viewed needs to be printed with stronger colors and contrast, not to let the filter reveal something else on the background.

For manufacturing the filtering device, such as a lens or a diffractive element, several methods can be used. A first method consists in manufacturing the filtering device in a separate step and inserting it inside the document during the lamination step of the overlay 24. This separate piece can also be fixedly attached by gluing, or by hot stamping for example.

In case the filtering device is a lens having a lenticular shape, a second method consists in pressing the lenticular shape directly into the upper plastic layer 24 during the lamination step or in a separate step after finalizing the document.

If the filtering device is made by printing, then it can be achieved simultaneously with the other printings or in a separate step, on a separate layer or even onto document's surface.

The identification document, which has just been described, together with its manufacturing process, enables to view different personalized information from both sides of the see-through portion. Moreover, the hidden information, which is only visible from one side, can be linked to other information printed on the remaining body of the document, near the area of the see-through portion, for easy reference and verification, so that it becomes impossible to remove the see-through portion and to replace it by another falsified piece.

1.-15. (canceled)

16. An identification document comprising
a translucent portion having a first side and a second side, the translucent portion comprising a first personalized information, the first personalized information comprising a second personalized information which is hidden in the first personalized information when viewed from the first side of the translucent portion; and
a filtering device attached to or formed in the second side of the translucent portion, the filtering device being configured to reveal the hidden second personalized information,
wherein the second personalized information appears superimposed onto the first personalized information when viewed from the second side of the translucent portion, and
wherein the second personalized information remains hidden when viewed from the first side of the translucent portion.

17. The identification document according to claim 16, wherein the filtering device has a lenticular shape.

18. The identification document according to claim 16, wherein the filtering device consists of printed parallel lines.

19. The identification document according to claim 16, wherein the filtering device consists of a diffractive element.

20. The identification document according to claim 16, wherein the first personalized information together with the second personalized information which is inserted into the first personalized information is provided inside a thickness of the translucent portion.

21. The identification document according to claim 16, wherein the first personalized information together with the second personalized information which is inserted into the first personalized information is provided on a surface of the first side of the translucent portion opposite to the filtering device.

22. The identification document according to claim 16, wherein the first personalized information is a picture of an owner of the identification document and the second personalized information is alphanumeric information relating to the identity of said owner.

23. The identification document according to claim 22, wherein the second personalized information is also at least partially visibly marked onto a remaining surface of the document near the translucent portion.

24. The identification document according to claim 16, wherein a thickness between the first personalized information comprising the second personalized information inserted within the first personalized information and the filtering device is at least 100 μm.

25. A method for manufacturing an identification document comprising a translucent portion having a first side and a second side, the translucent portion comprising a first personalized information, the method comprising:
processing an image, the image comprising the first personalized information together with a second personalized information inserted and hidden in the first personalized information;
inserting the processed image either into a thickness of the translucent portion or onto a surface of the first side of the translucent portion; and
providing a filtering device in or on the second side of the translucent portion such that the filtering device faces the processed image through the thickness of the translucent portion, the second personalized information appearing superimposed onto the first personalized information when viewed from the second side of the translucent portion, and the second personalized information remaining hidden and only the first personalized information appearing when viewed from the first side of the translucent portion.

26. The method according to claim 25, wherein the processed image is laser-engraved either into the thickness of the translucent portion or onto the surface of the first side of the translucent portion opposite to the filtering device.

27. The method according to claim 25, wherein the filtering device is obtained by pressing a plastic layer onto an area of the second side corresponding to an area of the translucent portion, such that the pressing action confers a lenticular shape to the pressed area.

28. The method according to claim 25, wherein the filtering device is obtained by printing a layer of the second side with parallel lines together with other printings of personalized information or in a separate step.

29. The method according to claim 25, wherein the filtering device is obtained by providing a diffractive element made separately and then fixedly attached to the translucent portion of the document by one of lamination, gluing or hot stamping.

30. The method according to claim 25, wherein the filtering device is made separately and then fixedly attached to a top of the translucent portion of the document at a last step by one of lamination, gluing, or hot stamping.
